(19) United States
(12) Patent Application Publication
(10) Pub. No.: US 2004/0238310 A1
(43) Pub. Date: Dec. 2, 2004

(54) Friction clutch

(75) Inventors: Horst Friedrich, Aidhausen (DE); Klaus-Peter Oberle, Bergrheinfeld (DE); Werner Selzam, Wipfeld (DE); Michael Istschenko, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/644,697

(22) Filed: Aug. 19, 2003

(30) Foreign Application Priority Data
Aug. 22, 2002 (DE) 102 38 366.9

(51) Int. Cl. F16D 13/50

(52) U.S. Cl. 192/70.27; 192/109 B

(57) ABSTRACT

A friction clutch includes a housing arrangement having an axis of rotation and an intermediate plate arrangement coupled to the housing arrangement for joint rotation therewith about an axis of rotation. The intermediate plate arrangement is arranged to transmit a pressure force and is preferably arranged between two frictional output members. The intermediate plate arrangement has two intermediate plate elements and an elastic prestressing arrangement therebetween. The two intermediate plate elements being displaceable with respect to one another counter to the action of the elastic prestressing arrangement.

### BACKGROUND OF THE INVENTION

1. Field of the Invention

The present invention relates to a friction clutch including a housing arrangement and an intermediate plate arrangement which is arranged between two frictional output members and coupled to a housing arrangement for joint rotation about an axis of rotation.

2. Description of the Related Art

Friction clutches used in the motor racing sector or in conjunction with high-powered drive assemblies are generally constructed such that they have a plurality of pairings of surfaces coming into frictional interaction with one another. These, on the one hand, are formed on frictional components held fixedly in terms of rotation on the housing side and, on the other hand, are provided on structural parts such as, for example, clutch disks or the like, to be coupled fixedly in terms of rotation to the transmission input shaft or shafts. During the engagement of friction clutches of this type, by the action of a force accumulator upon a pressure plate, the surfaces located opposite one another are brought into mutual friction bearing contact. With increasing pressure force during engagement, the clutch torque likewise increases.

So that a better meterability of the clutch torque and therefore of the torque transmitted to driving wheels can be obtained at the commencement of a coupling operation, conventional clutches have a lining resistance provided in the region of the clutch disks which, at the commencement of the coupling operation, counteract the engagement force provided by the force accumulator and thus assist a gradual rise of the clutch torque up to a maximum compression of said clutch. However, due to the very high load on the clutches used in motor racing clutches or in conjunction with high-powered drive assemblies, it is generally not possible or possible only with great difficulty to provide lining resilience which can withstand the loads that occur.

### SUMMARY OF THE INVENTION

The object of the present invention is to provide a friction clutch which, by the introduction of elasticity, makes it possible to have an improved meterability of the clutch torque at the commencement of an engagement operation.

According to the present invention, the object is met by a friction clutch including a housing arrangement and an intermediate plate arrangement which is coupled to the housing arrangement for joint rotation about an axis of rotation, in order to transmit a pressure force. The intermediate plate arrangement is preferably arranged between two frictional output members and comprises at least two intermediate plate elements displaceable with respect to one another counter to the action of an elastic prestressing arrangement.

In the friction clutch according to the invention, an elasticity is integrated into a subassembly tied on the housing side. This elasticity may be provided independently of the construction of a flywheel or of a pressure plate or of the construction of the frictional members to be coupled to the drive shaft or the drive shafts.

A large amount of construction space can be obtained in that at least one intermediate plate element comprises, on a side positioned so as to face another intermediate plate element, a recess for the partial reception of the prestressing arrangement. The recess may be designed, for example, as a ring-like depression which therefore extends essentially over the entire circumference of the respective intermediate plate element. In order to ensure that the intermediate plate arrangement is held together, it is proposed that the intermediate plate elements be held apart in a state of maximum mutual spacing, counter to the prestressing action of the prestressing arrangement, by holding-together members or retaining members. In this case, there may be provision for the retaining members to be formed by clinched bolts, screw bolts or any retaining fastener which holds the intermediate plates at a maximum mutual spacing.

The prestressing arrangement may comprise at least one spring element, for example at least one cup spring, at least one corrugated spring, or at least one elastomeric element or any element which exerts a spreading apart force on the intermediate plates.

So that the construction space present in a friction clutch can be utilized as efficiently as possible, it is proposed that at least one intermediate plate element has a frictional surface or carries a frictional lining element providing a frictional surface.

According to a further aspect, the present invention relates to an intermediate plate arrangement for a friction clutch, the intermediate plate arrangement comprising at least two intermediate plate elements displaceable with respect to one another counter to the action of an elastic prestressing arrangement.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements through the several views:

FIG. 1 is a longitudinal sectional view of a friction clutch according to the present invention;

FIG. 2 is an enlarged view of a detail of the intermediate plate used in the friction clutch of FIG. 1;

FIGS. 2a-2c are schematic views of various embodiments of prestressing arrangements for the intermediate plate of FIG. 2; and

FIG. 3 is an axial view of the intermediate plate illustrated in FIG. 2.

### DETAILED DESCRIPTION OF THE PRESENTLY PREFERRED EMBODIMENTS

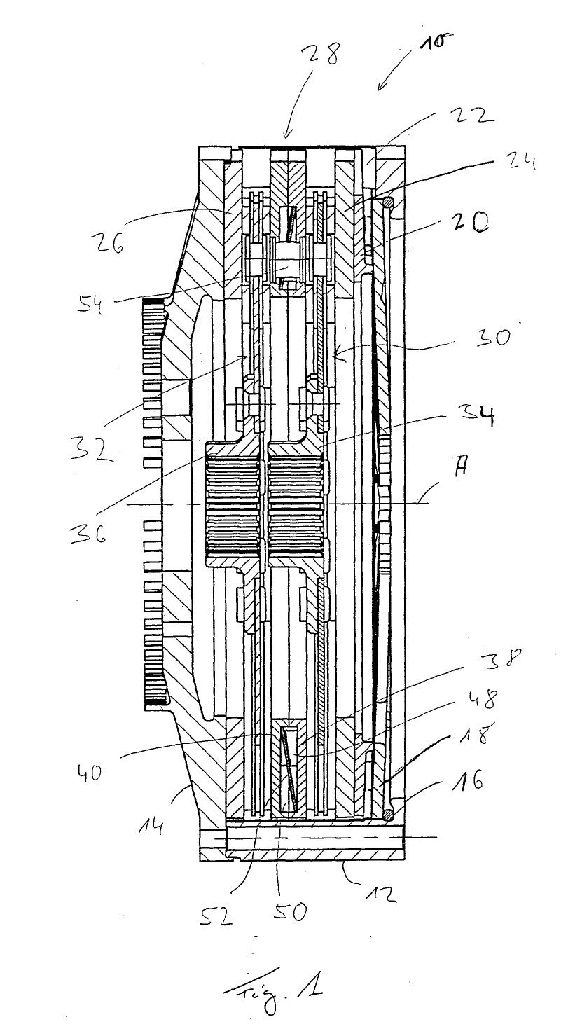

The clutch arrangement 10 illustrated in FIG. 1 comprises a housing arrangement 12 which is connected fixedly to a flywheel 14 on one axial side by screw bolts or other like fasteners. The other axial side of the housing arrangement 12 forms a supporting region 16 for a force accumulator 18 designed, for example, as a diaphragm spring. The force accumulator 18 acts upon a pressure plate 20 in a region located radially further inward from said supporting region. The pressure plate 20 is coupled fixedly in terms of rotation to the housing arrangement 12, but is displaceable with respect to the latter in the direction of the axis of rotation A. This rotationally fixed coupling may be effected by coupling portions 22 of the housing arrangement 12 which extend in the axial direction and which engage into respective coupling recesses of the pressure plate 20. Axially following the pressure plate 20 and also the flywheel 14, friction plates 24, 26 are provided, so that the pressure plate 20 and the flywheel 14 themselves do not become frictionally active for torque transmission, but merely serve for the application or support of pressure force.

Between the two friction plates 24, 26, which may, for example, be constructed completely from metal, lies an intermediate plate arrangement 28 which is also described in more detail below and which likewise is coupled fixedly in terms of rotation to the housing arrangement 12. Between the intermediate plate arrangement 28 and the friction plate 24 lie the friction linings of a clutch disk 30 and between the friction plate 26 and the intermediate plate arrangement 28 lie the friction linings of a clutch disk 32. Each of the two clutch disks 30, 32 includes a radially inner hub region 34, 36 which may be fixed in terms of rotation to an output shaft (not illustrated) such as, for example, a transmission input shaft. In principle, the friction clutch 10 illustrated in FIG. 1 may be considered as a double-disk clutch. It may be pointed out that the two clutch disks 30, 32 may, of course, be replaced by an inner-lamellae arrangement with a hub carrying the latter.

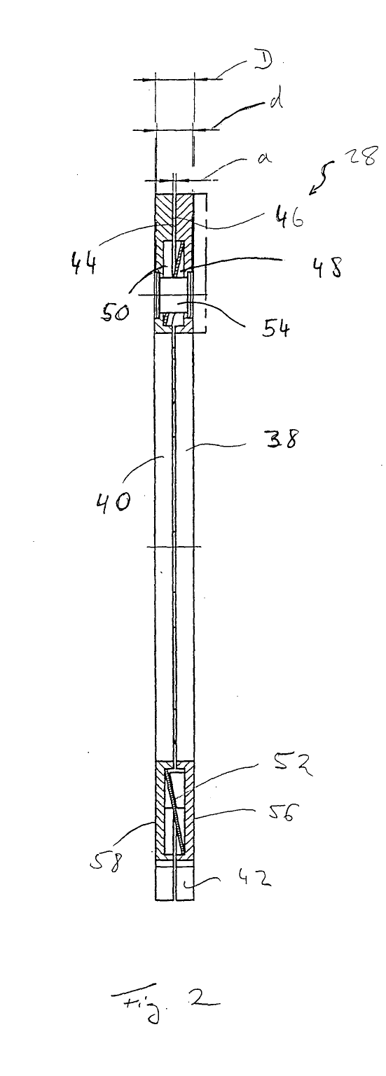

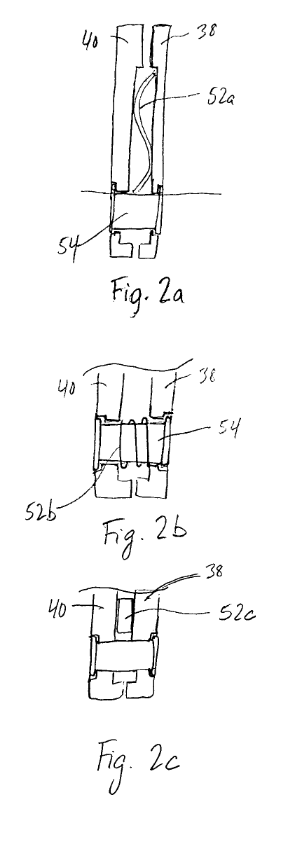

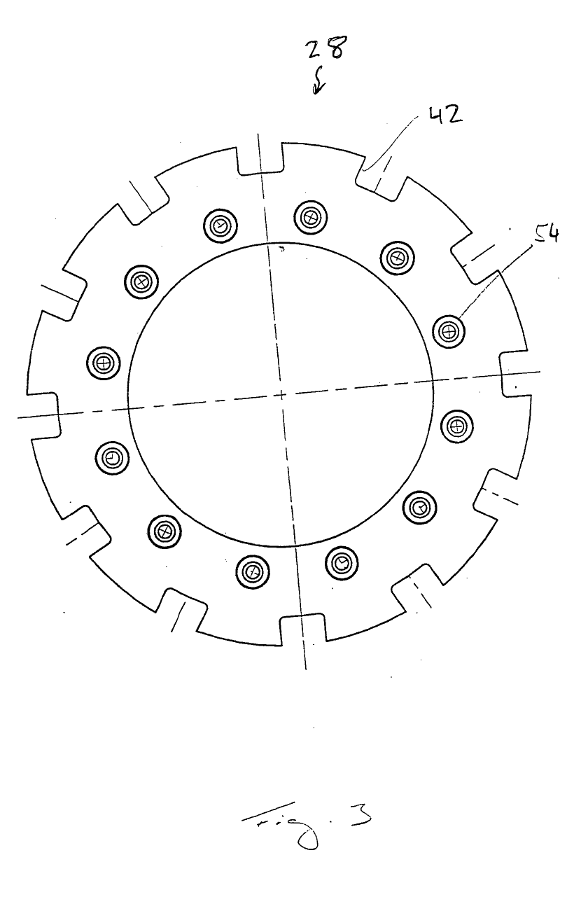

FIGS. 2 and 3 show the intermediate plate arrangement 28 in more detail. The intermediate plate arrangement 28 comprises two annular plate parts 38, 40 which are essentially structurally identical to one another and which in their radially outer region have recesses 42 for the rotationally fixed coupling to the housing arrangement 12. On their confrontingly opposed sides 44, 46, the two intermediate plate elements 38, 40 have, for example, annular depressions 48, 50 running around in a ring-like manner. These two depressions 48, 50 have arranged in them a prestressing arrangement in the form of a cup spring 52 which is supported in a radially inner region on the intermediate plate element 40 and is supported in a radially outer region on the intermediate plate element 38. By means of a plurality of members 54, for example clinched bolts, screw bolts or the like, which are provided so as to be distributed on the circumference, the two intermediate plate elements 38, 40 are held against one another such that, in the positioning illustrated in FIG. 2, with a maximum mutual spacing (a) therebetween, the two frictional surfaces 56, 58 provided on the intermediate plate elements 38, 40 have a maximum axial extent (D). The prestressing action of the cup spring 52 holds the two intermediate plate elements 38, 40 in position, with said cup spring being prestressed. Due to axial action during the engagement operation, the intermediate plate arrangement 28 is clamped between the two clutch disks 30, 32 or their frictional linings, so that the two intermediate plate elements 38, 40 are brought nearer to one another counter to the prestressing action of the cup spring 52 until they assume the state of minimum axial extent (d). Thus, at the transition from the state of maximum axial extent (D) to the state with the minimum axial extent (d), that is to say a state in which the two intermediate plate elements 38, 40 bear against one another, there is an axial elasticity which builds up a counterforce to the engagement force provided by the force accumulator 18 in the region of the intermediate plate arrangement 28. Owing to the build-up of this rising counterforce, the clutch torque may be set or varied in a highly defined manner during this transitional phase so that the drive torque reaching the driving wheels can be set or varied correspondingly accurately. This is of great importance, above all, in the starting phase of motor racing, in which, by the clutch being closed, the driving wheels are to be brought into a state in which they rotate in respect of the ground with a defined slip in the range of 10 to 15%.

By the intermediate plate arrangement 28 being configured according to the present invention, even a friction clutch capable of being used in motor racing may have integrated into it an elasticity which allows an exact metering of the clutch torque during engagement of the clutch. Furthermore, by virtue of the positioning of the prestressing arrangement, i.e., the cup spring 52, the friction clutch also does not suffer from and is able to handle the transmission of very high torques, in contrast to friction clutches having the conventional lining resiliences. It is, of course, possible that, in fields of use where correspondingly high torques do not have to be transmitted, the intermediate plate arrangement according to the invention may be combined with clutch disks which additionally also have a lining resilience and therefore make a further contribution to elasticity.

In the intermediate plate arrangement according to the present invention, the prestressing arrangement may comprise many diverse elements, such as, for example, the cup spring 52 shown in FIGS. 1-2. In addition, the prestressing arrangement may also comprise a corrugated spring 52a as shown in FIG. 2a. Alternatively, discrete spring elements distributed over the circumference such as, for example, helical compression springs 52b, which may then, if appropriate, be arranged so as to surround the coupling bolts 54 (FIG. 2b), or else a plurality of stacked spring elements may be provided as prestressing arrangement it is also possible, of course, to use solid elastomeric blocks 52c as shown in FIG. 2c. As already mentioned, frictional surfaces 56, 58 may be provided on the sides of the intermediate plate elements 38, 40 facing away from one another. It is also possible, of course, to provide on these intermediate plate elements frictional linings in the regions of which the frictional surfaces are then formed, or to use on both sides of the intermediate plate arrangement friction disks, such as are present, for example, as friction disks 24, 26 in FIG. 1. The intermediate plate elements 38, 40 may be designed as sheet metal parts, into which depressions 48, 50 are integrally formed or are worked by cutting. These plate elements may, of course, also be provided as castings. It is, of course, possible, further, to use the intermediate plate according to the invention in another axial region of a clutch, that is to say a region in which there is no positioning between two frictional members coupled to the output side, but, for example, as a replacement for at least one of the friction plates 24, 26 which are in contact with the pressure plate or the flywheel.

By virtue of the construction or use according to the present invention of an intermediate plate arrangement, elasticity can be obtained in the region of the clutch, without special measures having to be provided on the flywheel or the pressure plate. A further advantage of the construction according to the invention is that, in a friction clutch of this type, a wear of friction linings which occurs during operation can be compensated simply by exchanging an intermediate plate arrangement 28 of this type, in that an intermediate plate arrangement of greater thickness is installed, as is indicated by a broken line in the upper right portion of FIG. 2. A variation in the elasticity may be carried out by an exchange of the prestressing arrangement, i.e., a spring, but may also be effected by an exchange of the entire subassembly.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A friction clutch, comprising:
a housing arrangement having an axis of rotation; and
an intermediate plate arrangement coupled to said housing arrangement for joint rotation therewith about the axis of rotation, and arrangeable for transmitting a pressure force between two frictional output members, said intermediate plate arrangement including two intermediate plate elements with an elastic prestressing arrangement arranged therebetween, said intermediate plate elements being axially displaceable with respect to one another counter to the action of said elastic prestressing arrangement.

2. The friction clutch of claim 1, wherein at least one of said intermediate plate elements comprises, on a side facing the other of said intermediate plate elements, a recess for at least a partial reception of said prestressing arrangement.

3. The friction clutch of claim 2, wherein said recess comprises an annular depression.

4. The friction clutch of claim 1, wherein said intermediate plate elements are held apart in a state of maximum axial extent, counter to a prestressing action of said prestressing arrangement, by restraining members.

5. The friction clutch of claim 4, wherein said restraining members comprise one of clinched bolts and screw bolts.

6. The friction clutch of claim 1, wherein said prestressing arrangement comprises at least one spring element.

7. The friction clutch of claim 6, wherein said at least one spring element comprises one of a cup spring, a corrugated spring, an elastomeric element or a helical coil spring.

8. The friction clutch of claim 1, wherein at least one of said intermediate plate elements includes one of a frictional surface or a frictional lining element providing a frictional surface.

9. An intermediate plate arrangement for a friction clutch, the intermediate plate arrangement comprising two intermediate plate elements and an elastic prestressing arrangement arranged therebetween, said two intermediate plates being displaceable with respect to one another counter to a force exerted by said elastic prestressing arrangement.
